(19) United States
(12) Patent Application Publication
(10) Pub. No.: US 2025/0224515 A1
(43) Pub. Date: Jul. 10, 2025

(54) Lighting assembly for an optoelectronic sensor for the detection of objects in a monitored zone and optoelectonic sensor

(71) Applicant: SICK AG, Waldkirch (DE)

(72) Inventor: Jörn BÖDEWADT, Hamburg (DE)

(21) Appl. No.: 19/012,096

(22) Filed: Jan. 7, 2025

(30) Foreign Application Priority Data
Jan. 9, 2024 (DE) 102024100400.2

(51) Int. Cl. G01S 17/89; G01S 7/481

(52) U.S. Cl. CPC G01S 17/89; G01S 7/4815; G01S 7/4816

(57) ABSTRACT

An optoelectronic sensor arranged for the detection of objects in a monitored zone has a light transmitter arrangement configured for transmission of transmitted light into the monitored zone and includes at least one light source, a transmission optical arrangement having at least one transmission optical element and is configured for the focusing of transmitted light, and a diffusor arrangement having at least one linear diffusor and is arranged to scatter the focused transmitted light in one first spatial direction and to at least substantially leave the focused transmitted light unscattered in a second spatial direction, with the second spatial direction being orthogonal to the first spatial direction. The light transmitter arrangement, the transmission optical arrangement and the diffusor arrangement are configured to generate a strip-like transmitted light pattern of a plurality of lines of light on an object present in the monitored zone.

The present invention relates to a lighting assembly for an optoelectronic sensor that is arranged for the detection of objects in a monitored zone, having a light transmitter arrangement that is configured for the transmission of transmitted light into the monitored zone and that comprises at least one light source, having a transmission optical arrangement that comprises at least one transmission optical element and that is arranged for the focusing of transmitted light, and having a diffusor arrangement that comprises at least one linear diffusor and that is configured for the purpose of scattering the focused transmitted light in one first spatial direction and to at least substantially leave the focused transmitted light unscattered in a second spatial direction with the second spatial direction being orthogonal to the first spatial direction. The light transmitter arrangement, the transmission optical arrangement and the diffusor arrangement are configured to generate a strip-like transmitted light pattern on an object present in the monitored zone which strip-like transmitted light pattern comprises a plurality of lines of light.

Having regard to optoelectronic sensors that function in accordance with the principle of a light scanner, the lighting assembly and a receiving arrangement provided for the detection of received light signals are present at the same side of the monitoring zone. If an object is present in the monitored zone, the transmitted light transmitted by the light transmission arrangement is remitted at the surface of the object in the direction of the receiving arrangement, this means reflected in a diffuse manner or in a mirrored manner. The receiving arrangement can have a light receiver having a one-dimensional or a two-dimensional array of light sensitive receiving elements and a reception optical system for a spatially resolved detection of objects, with which, for example, a spatially resolved detection of an image of the transmission light pattern projected by the lighting assembly on the object can take place. Light receivers having a two-dimensional array of light sensitive reception elements typically have a matrix-like, rectangular and equidistant arrangement of reception elements in a plurality of lines.

In many cases of application it is desirable to obtain a spatial resolution not only in one or two lateral dimensions, but rather also in further dimensions in order to also determine a distance piece of information or depth piece of information with respect to the detected object. Such distance measuring optical sensors or distance measuring light scanners are also referred to as LIDAR sensors or LIDAR systems (LIDAR: abbreviation for “Light Detecting And Ranging”). Frequently specific light receivers are used for this type of sensors that, for example, are configured to determine the distance piece of information in accordance with a light propagation method. Such light receivers or sensor arrays are also referred to as TOF sensors (TOF: abbreviation for “Time Of Flight” as a synonym for the light propagation time). TOF sensors are configured to detect the runtime of a light pulse between the point in time of its transmission and the point in time of the detection of the light pulse correspondingly reflected at the object and indeed separately for each light sensitive element of the TOF sensor.

Frequently, such TOF sensors can only be readout line-wise, this means that always only one line of light sensitive elements of the TOF sensor can be evaluated at a certain point in time. For achieving a higher energy efficiency, in comparison to a complete irradiation of the monitored zone, on the generation of transmitted light and also for the avoidance of undesired crosstalk effects it is desirable to only illuminate those regions of the monitored zone respectively the surface of an object to be detected that can actually also be detected by the respective active line of the light receiver due to the geometry in the reception light path. For this reason the light transmitter arrangement is configured and operated in such a way that a strip-like transmission light pattern is generated which comprises a plurality of lines of light, wherein, for this purpose, the imaging properties of the light transmitter arrangement and the reception assembly are synchronized with respect to one another in such a way that a respective line of light of the transmission light pattern is imaged as centrally as possible at a line of the light receiver. The generation of the plurality of lines of light by way of example takes place sequentially through a subsequent activation of the individual light sources of the light transmitter arrangement.

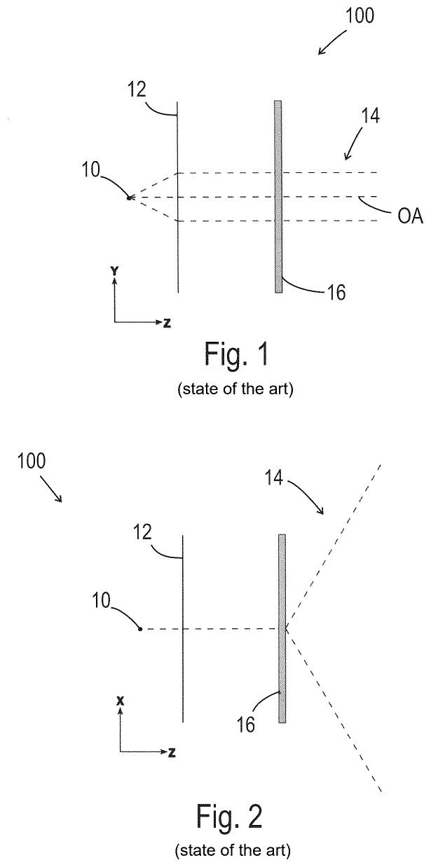

The problem underlying the invention on a generation of a strip-like transmission light pattern will be discussed in the following with reference to FIGS. 1 to 4 by means of a state of the art lighting assembly.

In accordance with the schematic FIGS. 1 and 2, the generation of an individual line of light can take place by means of a lighting assembly 100 in which a point light source 10 is arranged downstream of a transmission optics 12 that shapes the divergent transmission light emitted by the point light source 10 to a parallel light beam 14. A diffusor arrangement having a so-called 1D diffusor or linear diffusor 16 is arranged downstream of the transmission optics 12 which scatters this parallel light beam 14 in a first spatial direction in a fan-shaped manner (cf. FIG. 2: X-direction), whereas in the second spatial direction at least substantially, this means up to a degree unavoidable due to construction and manufacturing technology, no distortion of the beam takes place (cf. FIG. 1: Y-direction). Such a linear diffusor 16 can, for example, be configured as a plate or a foil having an effective zone that comprises linear structures that bring about the desired fan-shaped expansion of the light beam 14. Having regard to the linear diffusor 16 in accordance with FIGS. 1 to 3 these linear structures extend in the Y-direction.

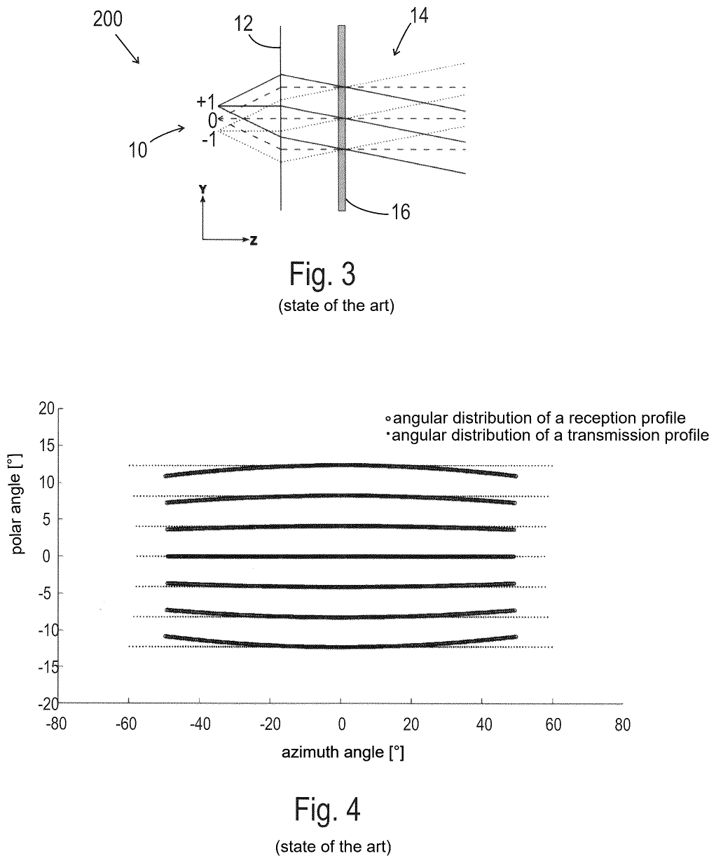

In order to generate a plurality of lines of light spaced apart from one another a lighting assembly 200 in accordance with FIG. 3 based on this can be provided, with the lighting assembly having a plurality of point light sources 10 that are laterally spaced apart from one another. Having regard to the lighting assembly 200, by way of example three point light sources 10 are provided that are referred to with “0”, “+1” and “−1” and that are arranged spaced from one another in the Y-direction. While the light beam 14 emitted by the point light source “0” extends along the optical axis OA of the lighting assembly 200, the light beams 14 of the point light sources “+1” and “−1” extend inclined downwardly respectively upwardly. Each of these light beams 14 are widened in a fan-like manner, whereby a transmission light pattern is generated that appears as a light pattern having a plurality of lines of light extending in parallel to one another straight through the angular space as will be described in more detail in the following.

Such a transmission light pattern or transmission profile is illustrated by way of example in FIG. 4 for a lighting assembly having seven point light sources. The angular distribution of the transmission profile for which the polar angle is shown above the azimuth angle is represented by a plurality of point-like symbols that appear in FIG. 4 as thin lines. The polar angle corresponds to the respective angle of inclination of the light beam 14 transmitted by a respective point light light source 10 with respect to the optical axis OA and for this reason corresponds to the Y-position of a respective symbol. The azimuth angle corresponds to a respective scattering angle of the fan-like widening and for this reason corresponds to the X-position of a respective symbol.

For an imaging of this transmission profile into a reception light pattern at a light receiver having a plurality of lines of reception elements it is preferred to use a reception optics which has an imaging function true to angle and is also referred to as a F-theta lens. The use of such a reception optics, however, leads to a distorted image of the transmission profile. A corresponding angular distribution of such a distorted reception light pattern or reception profile is illustrated in FIG. 4 with a plurality of circular symbols, which appear there as thicker lines. As can be readily seen in FIG. 4, the transmission profile, this means the angular profile generated by the transmission unit and the reception profile significantly deviate with respect to one another. Due to this deviation, an imaging of the transmission lines of light adapted to one of the lines of this light receiver is no longer possible. In particular at the borders the deviation leads thereto that corresponding boundary sections of the transmission lines of light are not or are only partially imaged at the associated lines of the light receiver.

It is an object of the invention to create a lighting assembly for an optoelectronic sensor with which a transmission light pattern can be generated which permits an imaging of a receiving light pattern at a light receiver composed of lines of light extending as straight as possible also with a distorting reception optics.

This object is satisfied by a lighting assembly having features of claim 1.

In accordance with the invention it is provided that an effective zone of the diffusor arrangement has a curvature that is configured in such a manner that a reference transmitted light pattern that would comprise lines of light extending straight on the generation by means of a reference diffusor arrangement having a planar effective zone in the angular space is distorted in such a way that the lines of light have a curved distorted pathway in the angular space.

A line of light that has a straight line extent in the angular space, this means described by the polar angle and the azimuth angle in a spatial polar coordinate system, is understood to be a respective line-shaped region for which the polar angle is the same for different azimuth angles. Correspondingly, a line of light that has a curved distorted extent in the angular space is understood to be a respective line-shaped region for which the polar angles differentiate from one another for different azimuth angles in the angular space.

The effective zone of the diffusor arrangement for a single linear diffusor corresponds to the effective zone or the effective region which brings about the above-mentioned scattering in one spatial direction. In as far as the diffusor arrangement comprises a plurality of linear diffusors, the effective zone of the diffusor arrangement is composed of the respective effective zones of the different linear diffusors. The curvature of the effective zone can thus have a continuous or a discrete extent which will be explained in detail in the following.

The mentioned reference transmission light pattern is, in particular a virtual transmission light pattern, that is introduced in this context in order to serve as a reference for the description of the effect of the diffusor arrangement curvature. The lines of light of the reference transmitted light pattern (corresponding to the transmission profile represented by the point-like symbols in FIG. 4) in this connection extend in the angular space, this means in a thought projection onto a shell of a sphere of a polar coordinate system in straight lines and, in particular also in parallel to one another. The planar effective zone of the reference diffusor arrangement in this consideration extends orthogonally to the optical axis of the lighting assembly.

The mentioned curved distorted extent of the lines of light of the “real” transmission light pattern is to be understood such that the lines of light respectively of the transmission light pattern have a distortion in the optical sense in the angular space, this means in the thought projection onto a shell of a sphere of the polar coordinate system. Such an optical distortion can be described, in particular thereby that the lines of light extend straight through a geometric center of the transmission pattern and lines of light that do not extend through the geometric center are curved, wherein the radius of curvature of a line of light becomes smaller with increasing distance of this line of light from the geometric center (this means the curvature becomes stronger for an increasing distance). If the lines of light extend convexly curved with respect to the geometric center this is referred to as a cushion-like distortion, if they extend concavely curved this is referred to as a barrel-like distortion.

The design of the lighting assembly in accordance with the invention permits an illumination of the monitored zone of an optoelectronic sensor in such a way with distorted line-shaped transmission light patterns that this distorted transmission light pattern can be imaged by a reception optics of a receiving assembly as a reception light pattern at a light receiver of the reception assembly whose lines have a distortion-free essentially straight line extent.

Generally the mentioned generation of a strip-like transmission light pattern is not to be exclusively understood such that all lines of light of this transmission light pattern have to be generated at the same point of time. Rather the transmission light pattern is preferably generated in such a way that the plurality of lines of light can also be generated after one another in time, this means sequentially. This will be explained in the following in more detail.

In accordance with a preferred embodiment the curvature of the effective zone of the diffusor arrangement extends only in one dimension, wherein the curvature extends in a plane that is spanned by an optical axis of the lighting assembly and the second spatial direction, with the optical axis extending through the light transmitter arrangement, the transmission optical arrangement and the diffusor arrangement. Consequently, the effective zone has no spherical curvature but a cylinder-shaped curvature. An axis of symmetry or central axis of this cylindrical shape of the effected zone thus correspondingly extends in the previously mentioned first spatial direction.

Advantageously the diffusor arrangement is arranged with respect to its curvature in such a manner that the mentioned axis of symmetry extends in parallel to the lines of light reception elements of an associated reception assembly.

In accordance with a further preferred embodiment the effective zone of a diffusor arrangement is concavely curved with respect to its side facing the transmission optical arrangement. This leads thereto that the transmission light pattern is distorted barrel-shaped in the angular space, this means in the intended projection onto a shell of a sphere of polar coordinate system. Alternatively, the effective zone of the diffusor arrangement with respect to its side-facing the transmission optical arrangement can also be curved convexly with respect to its side-facing transmission optical arrangement. This then leads thereto that the transmission light pattern appears distorted cushion-shaped in the angular space, this means in the intended projection onto a shell of a sphere of the polar coordinate system it. The selection of a convex or concave curvature of the effective zone preferably takes place in such a way that the distortion of a receiving optics associated with a receiving assembly can be compensated in an as complete as possible manner.

In accordance with a further preferred embodiment, the diffusor arrangement comprises a linear diffusor that is curved in accordance with the predefined curvature of the effective zone of the diffusor arrangement. Alternatively, the diffusor arrangement comprises a plurality of planar linear diffusors that are arranged and aligned in accordance with the predefined curvature of the effective zone of the diffusor arrangement. Thus, the curved effective zone can be imaged in a continuous manner by a single curved linear diffusor or approximated by a sequence of a plurality of planar linear diffusors.

In accordance with a further preferred embodiment, the light transmitter arrangement comprises a plurality of light sources that are arranged spaced apart from one another in a second spatial direction. Having regard to this design, each light source generates a respective line of light. Preferably, the plurality of light sources are arranged in a line, with this line extending in the second spatial direction.

Preferably the plurality of light sources can be sequentially activated, wherein only one light source is preferably active at a certain point in time. Hereby, on a use of the lighting assembly, in a distance measuring optoelectronic TOF sensor in which for technical reasons only one line of reception elements can be active at a certain point in time, an energetically inefficient lighting of non-detectable part regions of the monitored zone can be avoided.

Preferably a respective transmission optical element is associated with each of the light sources. Correspondingly, the transmission optical arrangement can be configured as a linear array or a micro-lens array of individual transmission optics. Alternatively, however, also a common transmission optics can be provided for all light sources.

Furthermore, it is preferred, if also a respective linear diffusor of a plurality of planar linear diffusors is associated with each of the light sources. In principle, the designs having a plurality of light sources and/or the design of having one or more transmission optics can also be combined with a design of the diffusor arrangement having a curved linear diffusor.

The present invention further relates to an optoelectronic sensor for the detection of objects in a monitored zone which comprises a lighting assembly in accordance with the invention and a reception arrangement which has a light receiver that comprises a plurality of light sensitive reception elements arranged in rows and columns and a reception optical arrangement that is configured to image a transmission light pattern into a reception light pattern at the reception arrangement, the transmission light pattern being generated by the lighting assembly at an object present in the monitored zone. The light receiver and the reception optics are configured and arranged in such a way that a respective line of light of the transmission light pattern is imaged at a respective line of the light receiver.

By means of this optoelectronic sensor the idea in line with the invention can be advantageously implemented, wherein an optical distortion brought about by the reception optics of the reception assembly can at least substantially be compensated by the diffusor arrangement designed in accordance with the invention. It is thereby achieved that the lines of a reception light pattern generated by an imaging of the transmission light pattern at the light receiver to a large extent coincides with the respective lines of light sensitive reception elements and in this way also the light incident at boundary regions of the light receiver can be at least approximately completely detected. It is thereby avoided that, due to an undesired curvature of the reception lenses, the sensitivity of the optoelectronic sensor is reduced at least for part regions in an undesirable manner.

In accordance with a preferred embodiment of the optoelectronic sensor the curvature of the effective zone of the diffusor arrangement and/or the spacing of the diffusor arrangement from the transmission optical arrangement are selected in such a manner that the distortion of a transmission light pattern brought about by the diffusor arrangement is counteracted by a distortion of the reception light pattern brought about by the reception optical arrangement. Preferably, the distortion of the transmission light pattern brought about by the diffusor arrangement at least substantially completely compensates the distortion of the reception pattern brought about by the reception optical arrangement. Thus the reception light pattern comprises reception lines that extend at least essentially in straight lines.

The expressions used in this context “at least essentially” respectively “essentially” are to be understood in this context in such a manner that the compensation of the distortion takes place in the scope of the possibilities available to construction respectively manufacturing. The deviations brought about by the manufacturing or construction from an ideal straight line extent or also deviations that are, by way of example, caused by curvatures of the surface of a real object, can be tolerated. The selection of the curvature in particular comprises optionally both the selection of a suitable direction of curvature, this means the selection of a convex or concave curvature, as well as optionally also the selection of a suitable radius of curvature. The selection of the spacing of the diffusor arrangement from the transmission optical arrangement can, in particular also comprise the setting of a desired work distance of the sensor.

In accordance with a further preferred embodiment of the optoelectronic sensor an evaluation unit is provided that is connected to the light transmitter arrangement and the light receiver, wherein the light transmitter arrangement comprises a plurality of light sources that can be sequentially activated by the evaluation unit, with the plurality of light sources being arranged spaced apart from one another in the second spatial direction, wherein each light source is associated with a corresponding line of the light receiver, wherein the evaluation unit is configured to determine the distance of a position of incidence of the transmission light pattern at an object surface of the object on the basis of a light propagation time between a respectively activated light source and a light sensitive element of the associated line of the light receiver in a spatially resolved manner. The hereby defined optoelectronic sensor is thus arranged for a distance measuring detection of objects in accordance with the principle of a LIDAR system.

Further advantages of the lighting assembly in accordance with the invention and of the optoelectronic sensor in accordance with the invention and advantageous embodiments result from the following description of the drawings. In the drawings, the embodiment of the invention are shown. The drawings, the description and the claims include numerous features in combination. The person skilled in the art will expediently also consider these features on their own and combine these two suitable further combinations.

There is shown:

FIGS. 1 to 3 schematic, not true to scale, sectional drawings of lighting assemblies in accordance with the state of the art;

FIG. 4 a diagram which represents angular distributions of a reception profile respectively of a transmission profile of an optoelectronic sensor in accordance with the state of the art;

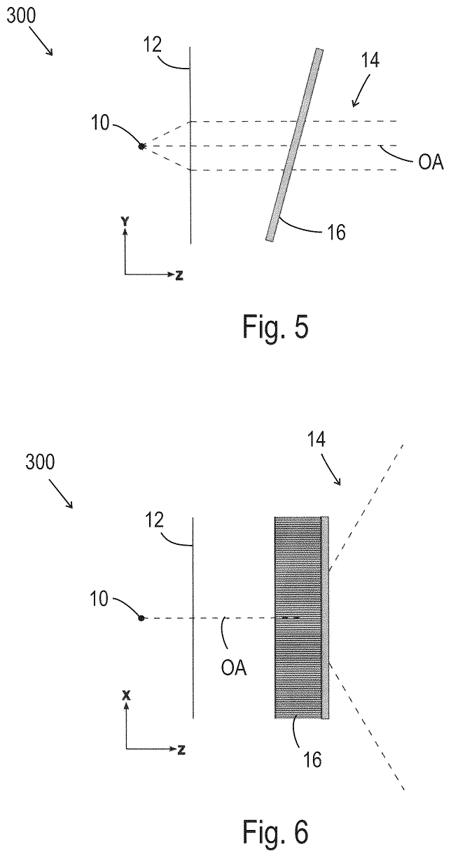

FIGS. 5 and 6 schematic, not true to scale, sectional illustrations of a lighting assembly in accordance with an embodiment that comprises a part of the features of the present invention;

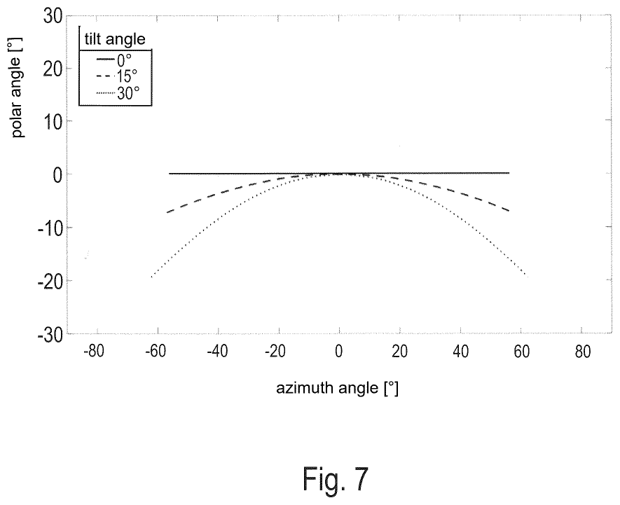

FIG. 7 a diagram that illustrates angular distributions of transmission profiles of a lighting assembly in accordance with FIGS. 5 and 6 for different tilt angles of the linear diffusor;

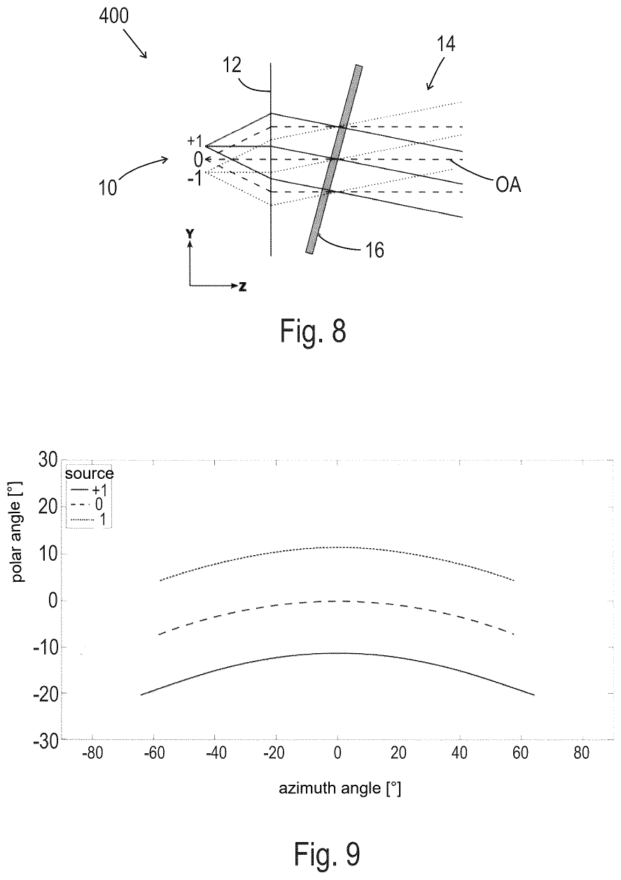

FIG. 8 a schematic, not true to scale, sectional drawing of a lighting assembly in accordance with a further embodiment that has a part of the features of the present invention;

FIG. 9 a diagram that illustrates angular distributions of a transmission profile of a lighting assembly in accordance with FIG. 8;

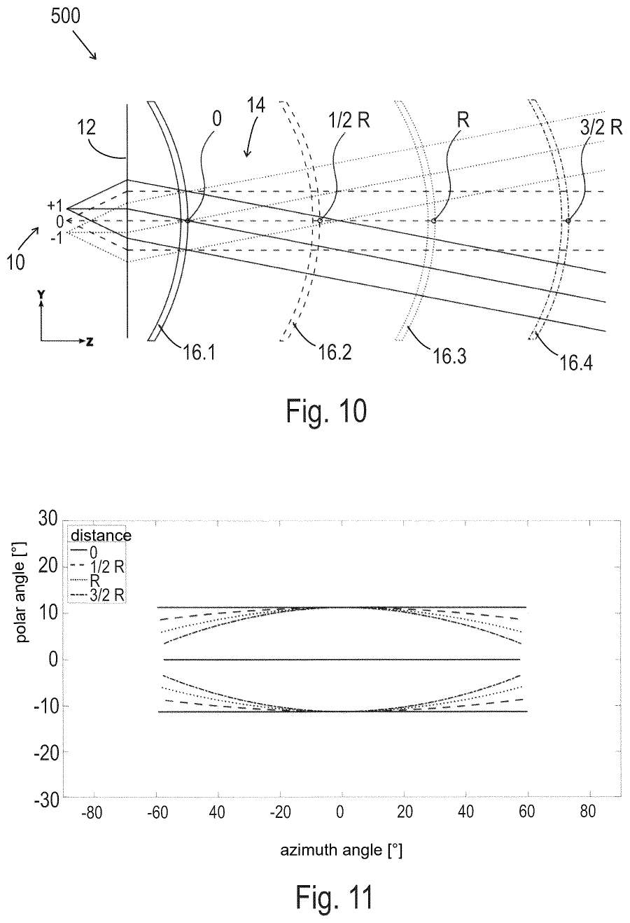

FIG. 10 a schematic, not true to scale, sectional illustration of a lighting assembly in accordance with an embodiment in accordance with the invention; and

FIG. 11 a diagram that illustrates angular distributions of transmission profiles of the lighting assembly of FIG. 10 for different spacings of a diffusor arrangement from a transmission optical arrangement.

In the following the same reference numerals are used for like or similar elements.

FIGS. 5 and 6 show schematic cross-sectional illustrations of a lighting assembly 300 in accordance with an embodiment that indeed does not show all features of the present invention, however, serves for a better understanding of the invention. The lighting assembly 300 is similar to the lighting assembly 100 of FIGS. 1 and 2 in such a way that now a focus is placed on the essential differences. In FIG. 5, that illustrates a sideview of the lighting assembly 300, the linear diffusor 16 in comparison to the corresponding FIG. 1 is arranged tilted with respect to the optical axis OA that extends through the point light source 10, the geometric center of the transmission optics 12 and the linear diffusor 16 and coincides with a beam of the transmission light beam 14, wherein the axis of inclination or tilting of the linear diffusor 16 extends in the X-direction and in this way extends transverse to the linear structures of the linear diffusor 16 respectively its effective zone. Correspondingly, the linear diffusor 16 in FIG. 6 appears extended in the Z-direction, with FIG. 6 showing a top view of the lighting assembly 300 illustrated in a side view in FIG. 5, wherein the strips extending in the interior of the linear diffusor 16 in the Z-direction represent the line-shaped scattering structures of the linear diffusor 16.

In the diagram of FIG. 7, angular distributions of three transmission profiles are illustrated which were generated by a lighting assembly 300 for different tilt angles of the linear diffusor 16, wherein the tilt angle relates to a tilt with respect to a vertical of the optical axis OA. Since the lighting assembly 300 (FIGS. 5 and 6) only has one point light source 10 in a simplified considered example, each of the three transmission profiles is only composed of one line of light. While the line of light of the transmission light profile for a tilt angle of 0° illustrated with the solid line of light (corresponds to the lighting assembly 100 of FIGS. 1 and 2 having a linear diffusor 16 aligned vertically to the optical axis OA) has a straight line extent, the extents of the dashed and/or dotted illustrated lines of light are curved for tilt angles of the extents different from 0°, wherein the curvature is larger the larger the tilt angle is. Thus, the curvature is weaker for a tilt angle of 15° (i.e. the radius of curvature is larger) than for a tilt angle of 30°.

FIG. 8 shows a lighting assembly 400 in accordance with a further embodiment which also does not show all of the features of the invention and for this reason should also serve for a better comprehension of the invention. The lighting assembly 400 of FIG. 8 in principle corresponds to a combination of the lighting assembly 200 (FIG. 3) with the lighting assembly 300 (FIGS. 5 and 6).

Correspondingly, the lighting assembly 400 of FIG. 8 has a total of three point-like sources 10 that are denoted with “+1”, “0” and “−1”. The linear diffusor 16 is arranged inclined with respect to the optical axis OA in a similar manner to the embodiment in accordance with FIGS. 5 and 6, this means it is tilted with respect to a vertical of the optical axis OA.

The angular distribution of a transmission profile generated by the lighting assembly 400 (FIG. 8) are illustrated in FIG. 9. The line types of the three lines of light of these angular distributions in FIG. 9 correspond to the line types of the light beams of the transmission light beams 14 in FIG. 8, this means the solid lines correspond to the point light source “+1”, the dashed lines correspond to the point light source “0” and the dotted lines correspond to the point light source “−1”. As can be easily recognized in FIG. 9 all lines of light have the same curvature respectively the same radius of curvature.

FIG. 10 shows a lighting assembly 500 in accordance with an embodiment in accordance with the invention. The lighting assembly 500 is similar to the lighting assembly 400 (FIG. 8), wherein the linear diffusor 16 respectively an effective zone of the linear diffusor 16 has/have a curved extent. The axis of symmetry of this curvature extends in the X-direction. In FIG. 10 the linear diffusor 16 is illustrated for four different spacings from the transmission optics 12 and is correspondingly provided with the reference numerals 16.1 to 16.4, wherein there the values of the spacing are given as relative spacings with respect to a focal point of the transmission optics 12 and a radius of curvature R of the linear diffusor 16. While the linear diffusor 16.1 illustrated as lined is present in the region of the focal point of the transmission optics 12 and thus has the spacing 0, the linear diffusor 16.2, illustrated as dashed, is provided at a position that is spaced apart from the focal point of the transmission optics 12 by half the radius of curvature R of the linear diffusor 16. The spacing of the linear diffusor 16.3 illustrated with the doted line corresponds to the radius of curvature R and the spacing of the linear diffusor 16.4 illustrated with the dotted-dashed line corresponds to the 1.5 multiple of the radius of curvature R.

In FIG. 11 angular distributions corresponding to FIG. 10 for the different spacings of the linear diffusor 16 from the transmission optics 12 and/or their focal points are illustrated, wherein the line types of these angular distributions correspond to the line types of the respective illustration of the linear diffusor 16.1 to 16.4. As can clearly be recognized in FIG. 11, the lines of light that were generated by the the point light source “0” lying at the optical axis OA have a straight extent for all spacings corresponding to the central line in FIG. 11. The lines of light generated for the two other point light sources “+1”, “−1” have for a spacing of the linear diffusor 16.1 of 0 likewise have a straight line extent. For the linear diffusor 16.2 to 16.4 spaced apart further from the transmission optics 12 the curvature of the lines of light increases with an increasing distance and correspondingly the radius of curvature of these lines of light decreases.

FIG. 11 in this way thus shows that through the selection of a suitable spacing and radius of curvature of the linear diffusor 16 and/or of its effective zone a transmission line pattern can be generated that has a barrel-shaped distortion corresponding to the embodiment of FIG. 10.

It is to be understood that the exemplary number of three point light sources 10 in the embodiment of FIG. 10 can be increased in a suitable manner in order to be adapted to the number of light sensitive elements of an associated light receiver.

As was explained in the foregoing with reference to FIGS. 5 to 7, the radius of curvature of the lines of light of the transmission light pattern amongst other things also depends on the angle of inclination of the linear diffusor 16 and in this way on the respectively effective angle of incidence of the transmission light beams at the effective zone of a planar linear diffusor 16. Due to this correlation between the angle of incidence of the transmission light beams at the effective zone of the linear diffusor 16 and the thereby achieved curvature of the lines of light, the person skilled in the art is in a position to select the spacing and the radius of curvature R of the linear diffusor respectively of the effective zone of a diffusor arrangement potentially composed of a plurality of linear diffusors in a manner corresponding to the desired extent of the curvature of the lines of light in the transmission light pattern, wherein this selection process can take place both empirically through suitable tests and also by way of calculation.

### LIST OF REFERENCE NUMERALS

100, 200, 300,
400, 500 lighting assembly
10 point light source
12 transmission optical element
14 transmitted light beam
16, 16.1-16.4 linear diffusor
OA optical axis

1. Lighting assembly for an optoelectronic sensor that is arranged for the detection of objects in a monitored zone, having a light transmitter arrangement that is configured for the transmission of transmitted light into the monitored zone and that comprises at least one light source,
having a transmission optical arrangement that comprises at least one transmission optical element and that is configured for the focusing of transmitted light, and
having a diffusor arrangement that comprises at least one linear diffusor and that is configured for the purpose of scattering the focused transmitted light in one first spatial direction and to at least substantially leave the focused transmitted light unscattered in a second spatial direction, with the second spatial direction being orthogonal to the first spatial direction,
wherein the light transmitter arrangement, the transmission optical arrangement and the diffusor arrangement are configured to generate a strip-like transmitted light pattern on an object present in the monitored zone which strip-like transmitted light pattern comprises a plurality of lines of light,
wherein
an effective zone of the diffusor arrangement has a curvature that is configured in such a manner that a reference transmitted light pattern that would comprise lines of light extending straight on the generation by means of a reference diffusor arrangement having a planar effective zone in the angular space is distorted in such a way that the lines of light have a curved distorted pathway in the angular space.

2. The lighting assembly in accordance with claim 1,
wherein
the curvature of the effective zone of the diffusor arrangement extends only in one dimension, wherein the curvature extends in a plane that is spanned by an optical axis of the lighting assembly and the second spatial direction, with the optical axis extending through the light transmitter arrangement, the transmission optical arrangement and the diffusor arrangement.

3. The lighting assembly in accordance with claim 1,
wherein
the effective zone of the diffusor arrangement is concavely curved with respect to its side facing the transmission optical arrangement.

4. The lighting assembly in accordance with claim 1,
wherein the diffusor arrangement comprises a linear diffusor that is curved in accordance with the predefined curvature of the effective zone of the diffusor arrangement.

5. The lighting assembly in accordance with claim 1,
wherein
the light transmitter arrangement has a plurality of light sources that are arranged in the second spatial direction spaced apart from one another.

6. The lighting assembly in accordance with claim 5,
wherein
the plurality of light sources can be sequentially activated.

7. The lighting assembly in accordance with claim 6,
wherein
each of the light sources is associated with a respective transmission optical element.

8. Optoelectronic sensor for the detection of objects in a monitored zone,
having a lighting assembly in accordance with claim 1, and
having a reception arrangement having a light receiver that comprises a plurality of light sensitive reception elements arranged in lines and columns, and a reception optical arrangement that is configured to image a transmission light pattern that was generated by the lighting assembly at an object present in the monitored zone for imaging into a reception light pattern at the reception arrangement, wherein the light receiver and the reception arrangement are configured and arranged in such a way that a respective line of light of the transmission light pattern is imaged at a respective line of the light receiver.

9. The optoelectronic sensor in accordance with claim 8,
wherein
the curvature of the effective zone of the diffusor arrangement and/or the spacing of the diffusor arrangement from the transmission optical arrangement are selected in such a manner that the distortion of the transmission light pattern brought about by the diffusor arrangement is counteracted by a distortion of the reception light pattern brought about by the reception arrangement.

10. The optoelectronic sensor in accordance with claim 8,
wherein
an evaluation unit is provided that is connected to the light transmitter arrangement and the light receiver, wherein the light transmitter arrangement comprises a plurality of light sources that can be sequentially activated by the evaluation unit, with the plurality of light sources being arranged spaced apart from one another in the second spatial direction, wherein each light source is associated with a corresponding line of the light receiver, wherein the evaluation unit is configured to determine the distance of a position of incidence of the transmission light pattern at an outer surface of the object on the basis of a light propagation time between a respectively activated light source and a light sensitive element of the associated line of the light receiver in a spatially resolved manner.

11. The lighting assembly in accordance with claim 1, wherein the diffusor arrangement comprises a plurality of planar linear diffusors that are arranged and aligned in accordance with the predefined curvature of the effective zone of the diffusor arrangement.
